(19) United States
(12) Patent Application Publication
(10) Pub. No.: US 2025/0174848 A1
(43) Pub. Date: May 29, 2025

(54) BATTERY CELL AND BATTERY MODULE

(71) Applicant: SAMSUNG SDI CO., LTD., Yongin-si (KR)

(72) Inventor: Young Jin HEO, Suwon-si (KR)

(21) Appl. No.: 18/667,328

(22) Filed: May 17, 2024

(30) Foreign Application Priority Data
Nov. 29, 2023 (KR) 10-2023-0169417

(51) Int. Cl. H01M 50/567; H01M 50/103; H01M 50/15; H01M 50/209; H01M 50/507; H01M 50/55; H01M 50/566

(52) U.S. Cl. CPC H01M 50/567; H01M 50/103; H01M 50/15; H01M 50/209; H01M 50/507; H01M 50/55; H01M 50/566

(57) ABSTRACT

A battery cell and a battery module are disclosed. A battery cell includes one or more electrode assemblies, each including a positive electrode and a negative electrode, a case in which the one or more electrode assemblies are arranged, a cap cover configured to cover an opening of the case, terminals assembled to the cap cover through the cap cover, and tab welding portions configured to weld lower portions of the terminals and an electrode tab arranged on the electrode assembly.

### CROSS-REFERENCE TO RELATED APPLICATION

The present application claims priority to and the benefit of Korean Patent Application No. 10-2023-0169417, filed on Nov. 29, 2023 in the Korean Intellectual Property Office, the entire disclosure of which is incorporated herein by reference.

### BACKGROUND

### 1. Field

Aspects of embodiments of the present disclosure relate to a battery cell and a battery module.

### 2. Discussion of Related Art

In general, as the demand for portable electronic products, such as laptops, video cameras, and portable phones rapidly increases, and robots, electric vehicles, and the like are commercialized in earnest, research on high-performance secondary batteries capable of repeated charging and discharging is actively underway.

Secondary batteries are widely used for driving or storing energy in small devices, such as portable electronic devices, as well as medium to large-sized devices, such as electric vehicles and energy storage systems (ESS). In particular, in the case of medium to large-sized devices, a battery module may be constituted by a plurality of battery cells electrically connected to each other to improve output and/or capacity of a battery.

Battery modules in the related art maintain durability by applying a certain level of surface pressure to battery cells through a housing structure installed to surround the battery cells.

The above-described information disclosed in the technology that forms the background of the present disclosure is provided to improve understanding of the background of the present disclosure, and thus may include information that does not constitute the related art.

### SUMMARY

According to an aspect of embodiments of the present disclosure, a battery cell capable of reducing resistance by reducing a number of parts while improving a fastening force of a terminal and a battery module including the same are provided.

According to another aspect of embodiments of the present disclosure, a battery cell capable of maintaining a sealing force while reducing a number of parts is provided.

These and other aspects and features of the present disclosure will be described in or will be apparent from the following description of some example embodiments of the present disclosure.

According to one or more embodiments of the present invention, a battery cell includes one or more electrode assemblies, each including a positive electrode and a negative electrode, a case in which the one or more electrode assemblies are arranged, a cap cover configured to cover an opening of the case, a terminal assembled to the cap cover through the cap cover, and a tab welding portion configured to weld a lower portion of the terminal and an electrode tab arranged on the electrode assembly.

The cap cover may include a cap plate configured to cover the case, a cap hole extending through the cap plate and configured to allow the terminal to pass therethrough, and a cap protrusion on the cap plate and protruding around the cap hole.

The terminal may include a terminal body passing through the cap cover, a lower nut coupled to a lower portion of the terminal body and welded to the electrode tab, an upper nut coupled to an upper portion of the terminal body, and a terminal insertion portion made of an insulating material and arranged between the cap cover and the terminal body.

The terminal body may include a body boss passing through the cap cover, a boss lower section below the body boss, below the cap cover, and screw-coupled to the lower nut, and a boss upper section on the body boss, arranged above the cap cover, and screw-coupled to the upper nut.

The terminal body may further include a body stopper on the body boss and configured to restrict movement of the lower nut and the upper nut.

The terminal insertion portion may include a lower insertion portion between the lower nut and the cap cover, a middle insertion portion between the cap cover and the terminal body, and an upper insertion portion connected to the middle insertion portion and arranged between the upper nut and the cap cover.

An upper groove may be formed in the upper insertion portion, and the upper nut may include an upper nut protrusion inserted in the upper groove.

The lower insertion portion and the middle insertion portion may include a stacked portion in which portions of the lower insertion portion and the middle insertion portion vertically overlap.

The terminal may include a first terminal above the cap cover, a second terminal extending downward from the first terminal and passing through the cap cover, a third terminal below the cap cover and configured to allow the second terminal to pass therethrough to be coupled to the electrode tab, a fourth terminal coupled to a lower end of the second terminal to restrain the third terminal, and a fifth terminal made of an insulating material and arranged between the cap cover and the first terminal, the second terminal, and the third terminal.

The electrode tab may be welded to at least one of the third terminal and the fourth terminal.

According to one or more embodiments of the present invention, a battery module includes cases in which one or more electrode assemblies, each including a positive electrode and a negative electrode, are arranged, the cases arranged in a row, cap covers configured to cover openings of the cases, respectively, terminals assembled to the cap covers through the cap covers, respectively, tab welding portions configured to weld lower portions of the terminals and electrode tabs arranged on the electrode assemblies, a housing accommodating the cases; and a bus bar configured to connect the terminals.

The cap cover may include a cap plate configured to cover the case, a cap hole extending through the cap plate such that the terminal is configured to pass through, and a cap protrusion on the cap plate and protruding around the cap hole.

The terminal may include a terminal body passing through the cap cover, a lower nut coupled to a lower portion of the terminal body and welded to the electrode tab, an upper nut coupled to an upper portion of the terminal body, and a terminal insertion portion made of an insulating material and arranged between the cap cover and the terminal body.

The terminal body may include a body boss passing through the cap cover, a boss lower section below the body boss, below the cap cover, and screw-coupled to the lower nut, and a boss upper section on the body boss, arranged above the cap cover, and screw-coupled to the upper nut.

The terminal body may further include a body stopper on the body boss and configured to restrict movement of the lower nut and the upper nut.

The terminal insertion portion may include a lower insertion portion between the lower nut and the cap cover, a middle insertion portion between the cap cover and the terminal body, and an upper insertion portion connected to the middle insertion portion and arranged between the upper nut and the cap cover.

An upper groove may be formed in the upper insertion portion, and the upper nut may include an upper nut protrusion inserted in the upper groove.

The lower insertion portion and the middle insertion portion may include a stacked portion in which portions of the lower insertion portion and the middle insertion portion vertically overlap.

The terminal may include a first terminal above the cap cover, a second terminal extending downward from the first terminal and passing through the cap cover, a third terminal below the cap cover and configured to allow the second terminal to pass therethrough to be coupled to the electrode tab, a fourth terminal coupled to a lower end of the second terminal to restrain the third terminal, and a fifth terminal made of an insulating material and arranged between the cap cover and the first terminal, the second terminal, and the third terminal.

The electrode tab may be welded to at least one of the third terminal and the fourth terminal.

However, aspects and effects obtainable through the present disclosure are not limited to the above aspects and effects, and other technical aspects and effects that are not mentioned will be clearly understood by those skilled in the art from the following description of the present disclosure.

### BRIEF DESCRIPTION OF THE DRAWINGS

The drawings attached to this specification illustrate some embodiments of the present disclosure, and further describe aspects and features of the present disclosure together with the detailed description of the present disclosure. However, the present disclosure should not be construed as being limited to the drawings:

FIG. 1 is a perspective view schematically illustrating a battery cell according to an embodiment of the present invention;

FIG. 2 is a cross-sectional view schematically illustrating the battery cell according to an embodiment of the present invention;

FIG. 3 is a view schematically illustrating a cap cover according to an embodiment of the present invention;

FIG. 4 is an exploded view schematically illustrating a terminal according to an embodiment of the present invention;

FIG. 5 is an assembled view schematically illustrating the terminal according to an embodiment of the present invention;

FIG. 6 is a view schematically illustrating a terminal insertion portion according to an embodiment of the present invention;

FIG. 7 is a view schematically illustrating an upper insertion portion for maintaining airtightness in FIG. 6, according to another embodiment;

FIG. 8 is a view schematically illustrating a lower insertion portion and a middle insertion portion for maintaining airtightness in FIG. 6, according to another embodiment;

FIG. 9 is a view schematically illustrating a lower welding portion and an upper welding portion according to an embodiment of the present invention;

FIG. 10 is a cross-sectional view schematically illustrating a terminal according to another embodiment of the present invention;

FIG. 11 is a view schematically illustrating a state in which an electrode tab is disposed between a third terminal and a fourth terminal of FIG. 10;

FIG. 12 is a view schematically illustrating a state in which the electrode tab is disposed outside the third terminal and the fourth terminal of FIG. 10;

FIG. 13 is a perspective view schematically illustrating a battery module according to an embodiment of the present invention; and

FIG. 14 is a cross-sectional view schematically illustrating the battery module according to an embodiment of the present invention.

### DETAILED DESCRIPTION

Herein, some embodiments of the present disclosure will be described, in further detail, with reference to the accompanying drawings. The terms or words used in this specification and claims are not to be construed as being limited to the usual or dictionary meaning and should be interpreted as meaning and concept consistent with the technical idea of the present disclosure based on the principle that the inventor can be his/her own lexicographer to appropriately define the concept of the term.

The embodiments described in this specification and the configurations shown in the drawings are provided as some example embodiments of the present disclosure and do not represent all of the technical ideas, aspects, and features of the present disclosure. Accordingly, it is to be understood that there may be various equivalents and modifications that may replace or modify the embodiments described herein at the time of filing this application.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.” Expressions such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It is to be understood that, although the terms “first,” “second,” “third,” etc. may be used herein to describe various elements, components, regions, layers, and/or sections, these elements, components, regions, layers, and/or sections are not to be limited by these terms. These terms are used to distinguish one element, component, region, layer, or section from another element, component, region, layer, or section.

Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are the same or substantially the same. Thus, the phrase “the same” or “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being arranged (or located or positioned) on the “above (or below)” or “on (or under)” a component, it may mean that the arbitrary element is placed in contact with the upper (or lower) surface of the component and may also mean that another component may be interposed between the component and any arbitrary element arranged (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the another part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

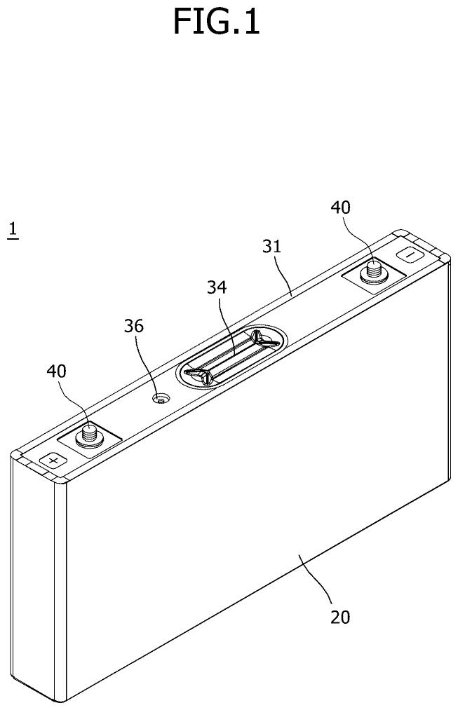

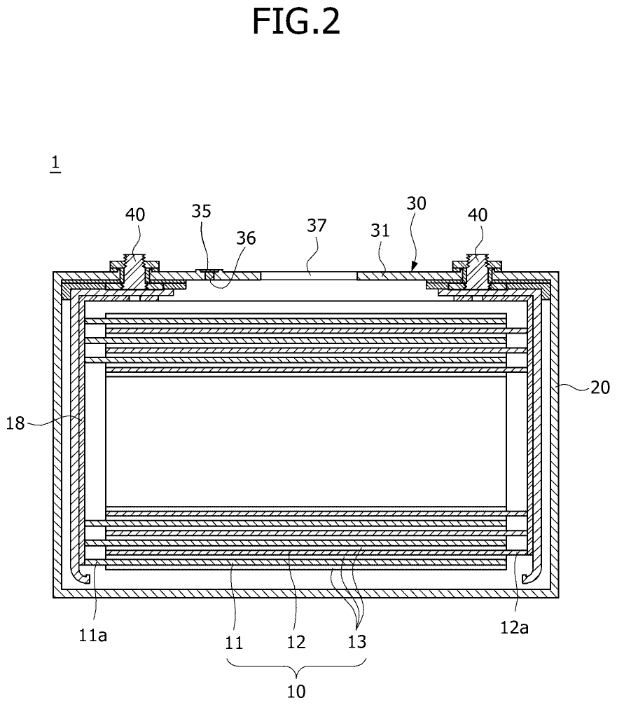

FIG. 1 is a perspective view schematically illustrating a battery cell according to an embodiment of the present invention; and FIG. 2 is a cross-sectional view schematically illustrating the battery cell according to an embodiment of the present invention. Referring to FIGS. 1 and 2, a battery cell 1 according to an embodiment of the present invention includes an electrode assembly 10, a case 20, a cap cover 30, and a terminal 40. A tab welding portion 48 welds a lower portion of the terminal 40 and an electrode tab 18 provided on the electrode assembly 10.

In an embodiment, one or more electrode assemblies 10 may be wound with

a separator 13, which is an insulator, interposed between a positive electrode 11 and a negative electrode 12. The positive electrode 11 and the negative electrode 12 may include a coated portion, which is a region where a current collector formed of a thin metal foil is coated with an active material, and uncoated portions 11a and 12a, which are regions that are not coated with the active material. In an embodiment, the positive electrode 11 and the negative electrode 12 may be wound after interposing the separator 13, which is an insulator, therebetween. However, the present invention is not limited thereto, and the electrode assembly 10 may have a structure in which positive electrodes and negative electrodes composed of a plurality of sheets are alternately stacked with a separator interposed therebetween.

The electrode assembly 10 may be built into, or housed or arranged in, the case 20. The case 20 may form an overall exterior of the battery cell 1, and may be made of a conductive metal, such as aluminum, an aluminum alloy, or nickel-plated steel. In addition, the case 20 may have an open upper side, or opening, and provide a space in which the electrode assembly 10 is accommodated.

The cap cover 30 may cover an open region of the case 20. The cap cover 30 may be coupled to an upper side of the case 20 and may cover the open region of the case 20. The cap cover 30 in contact with the case 20 may be made of a conductive material.

The terminal 40 may be assembled to the cap cover 30 through the cap cover 30. The terminal 40 may be connected to the electrode assembly 10. The terminal 40 may pass through the cap cover 30, and a lower portion thereof may be built into or coupled to the case 20 and in contact with the electrode assembly 10, and an upper portion may protrude out of the case 20. The electrode tab 18 connected to the electrode assembly 10 may be in contact with the terminal 40.

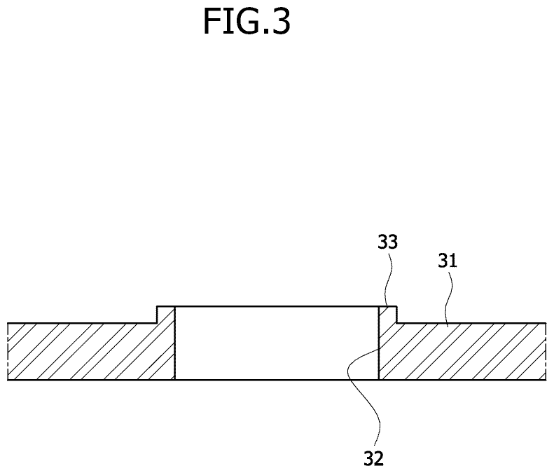

FIG. 3 is a view schematically illustrating the cap cover according to an embodiment of the present invention. Referring to FIGS. 2 and 3, the cap cover 30 may include a cap plate 31, a cap hole 32, and a cap protrusion 33.

The cap plate 31 may be made of a thin plate and coupled to an opening of the case 20. An electrolyte injection port 36 into which a sealing stopper 35 may be installed may be formed on the cap plate 31, and a vent 37 having a notch 34 formed thereon may be installed.

The vent 37 may be opened and closed in conjunction with changes in internal pressure of the case 20. That is, the vent 37 may remain in a closed state and seal the case 20 during normal operation of the electrode assembly 10. The vent 37 may open as the internal pressure of the case 20 rises above a certain level (e.g., a set level), such as due to overcharging or fire, and discharge emissions, such as flame and gas, from the inside of the case 20 to the outside of the case 20.

The cap hole 32 may be formed in the cap plate 31 and allow the terminal 40 to pass therethrough. In an embodiment, two cap holes 32 may be formed in the cap plate 31 to allow positive electrode and negative electrode terminals 40 to pass therethrough, respectively. In an embodiment, the cap hole 32 may be formed through additional processing of the molded cap plate 31. However, the cap hole 32 may be generated while molding the cap plate 31.

The cap protrusion 33 may be formed on the cap plate 31 and may protrude around the cap hole 32. In an embodiment, the cap protrusion 33 has a circular band shape in a cross-section to suppress inflow of foreign substances through the cap hole 32.

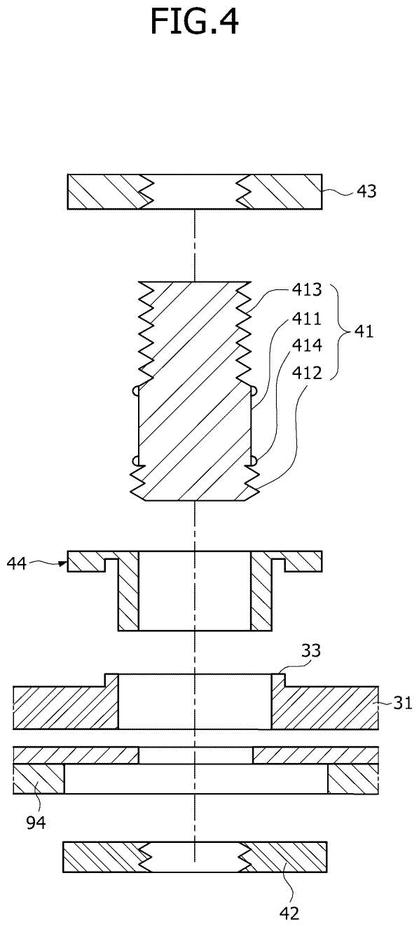

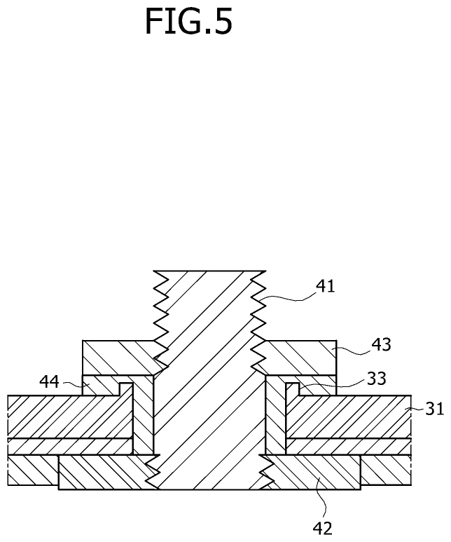

FIG. 4 is an exploded view schematically illustrating a terminal according to an embodiment of the present invention; and FIG. 5 is an assembled view schematically illustrating the terminal according to an embodiment of the present invention. Referring to FIGS. 4 and 5, the terminal 40 may include a terminal body 41, a lower nut 42, an upper nut 43, and a terminal insertion portion 44.

The terminal body 41 may pass through the cap cover 30. The lower nut 42 may be coupled to a lower portion of the terminal body 41 and connected to the electrode assembly 10. The upper nut 43 may be coupled to an upper portion of the terminal body 41. The terminal body 41, the lower nut 42, and the upper nut 43 may be made of a conductive material. The lower nut 42 may be disposed below the cap cover 30 and built into or arranged within the case 20. The upper nut 43 may be disposed above the cap cover 30. In an embodiment, the lower nut 42 may have a ring shape with rounded edges, and the upper nut 43 may have an angulated edge shape.

The terminal insertion portion 44 made of an insulating material may be disposed between the cap cover 30 and the terminal body 41. In an embodiment, the terminal insertion portion 44 may be divided into multiple pieces. The terminal insertion portion 44 may be disposed between the cap cover 30 and the lower nut 42 to prevent or substantially prevent the cap cover 30 and the lower nut 42 from coming into direct contact. The terminal insertion portion 44 may be disposed between the terminal body 41 and the cap hole 32 to prevent or substantially prevent the cap cover 30 and the terminal body 41 from coming into direct contact. The terminal insertion portion 44 may be disposed between the cap cover 30 and the upper nut 43 to prevent or substantially prevent the cap cover 30 and the upper nut 43 from coming into direct contact.

The terminal body 41 may include a body boss 411, a boss lower section 412, and a boss upper section 413.

The body boss 411 may pass through the cap cover 30. The body boss 411 may have a cylindrical shape and pass through the cap plate 31 via the cap hole 32.

The boss lower section 412 may be formed below the body boss 411, disposed below the cap cover 30, and screw-coupled to the lower nut 42. The boss lower section 412 may be a region where threads are formed from a low point of the body boss 411 to a set height.

The boss upper section 413 may be formed on the body boss 411, disposed above the cap cover 30, and screw-coupled to the upper nut 43. The boss upper section 413 may be a region where threads are formed from a high point of the body boss 411 to a set height.

In an embodiment, in the boss lower section 412 and the boss upper section 413, threads may be formed in opposite directions. That is, when pitch directions of the threads formed in the boss lower section 412 and the boss upper section 413 are formed in opposite directions, even when one of the lower nut 42 or the upper nut 43 screw-coupled thereto is rotated together with the terminal body 41, loosening of the other one of the lower nut 42 or the upper nut 43 may be suppressed. However, depending on a work environment, the threads may be formed in a same direction in the boss lower section 412 and the boss upper section 413.

The terminal body 41 may further include a body stopper 414. The body stopper 414 may be formed on the body boss 411 and may restrict movement of the lower nut 42 and the upper nut 43. The body stopper 414 may be formed integrally with the body boss 411 or mounted on the body boss 411. The body stopper 414 may protrude out of the body boss 411 such that excessive tightening of the lower nut 42 and the upper nut 43, which are tightened in a thread direction, may be prevented or substantially prevented. The lower nut 42 and the upper nut 43 may be stopped by the body stopper 414 after reaching a certain tightening position (e.g., a set tightening position).

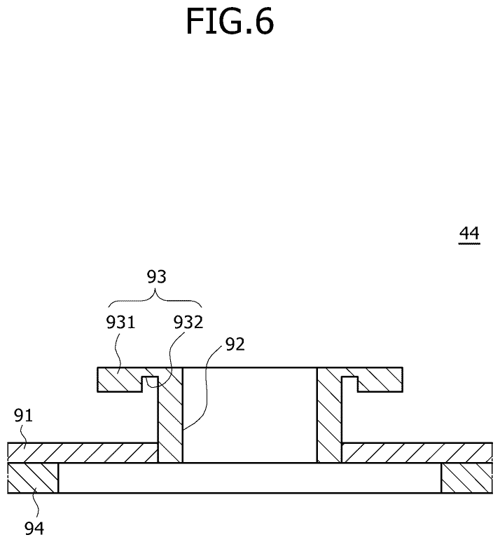

FIG. 6 is a view schematically illustrating a terminal insertion portion according to an embodiment of the present invention. Referring to FIG. 6, a terminal insertion portion 44 may include a lower insertion portion 91, a middle insertion portion 92, and an upper insertion portion 93. The terminal insertion portion 44 may include an insulating material, and, in an embodiment, all or part thereof may be molded including a shrinkable material to maintain airtightness.

The lower insertion portion 91 may be disposed between the lower nut 42 and the cap cover 30. The lower insertion portion 91 may be attached to a bottom surface of the cap plate 31 corresponding to a periphery of the cap hole 32. The lower insertion portion 91 may extend to an inner wall of the case 20 and support the electrode tab 18 such that the electrode tab 18 does not contact the case 20.

In an embodiment, a side insertion portion 94 surrounding the lower nut 42 may be attached to a bottom surface of the lower insertion portion 91. In an embodiment, the side insertion portion 94 may be formed integrally with the lower insertion portion 91.

The middle insertion portion 92 may be disposed between the cap cover 30 and the terminal body 41. The middle insertion portion 92 may have a cylindrical shape to be inserted into the cap hole 32 and surround the terminal body 41. A lower end of the middle insertion portion 92 may be supported by the lower nut 42. In an embodiment, a lower end of the middle insertion portion 92 may be seated on the lower insertion portion 91. In an embodiment, the middle insertion portion 92 may be manufactured separately from the lower insertion portion 91.

The upper insertion portion 93 may be connected to the middle insertion portion 92 and disposed between the upper nut 43 and the cap cover 30. The upper insertion portion 93 may be formed integrally with the middle insertion portion 92, or may be manufactured separately. The upper insertion portion 93 may be seated on the cap plate 31 corresponding to a periphery of the cap hole 32, and may be in close contact with the upper nut 43 to block inflow of foreign substances. The upper insertion portion 93 may include an insertion upper body 931 connected to an upper end of the middle insertion portion 92 and seated on the cap plate 31 to surround the periphery of the cap hole 32 and an insertion groove 932 that is formed in a bottom surface of the insertion upper body 931 and into which the cap protrusion 33 is inserted. When the cap protrusion 33 is inserted into the insertion groove 932, movement of the upper insertion portion 93 may be suppressed. Movement of foreign substances introduced between the upper insertion portion 93 and the cap plate 31 toward the cap hole 32 may be blocked by the cap protrusion 33.

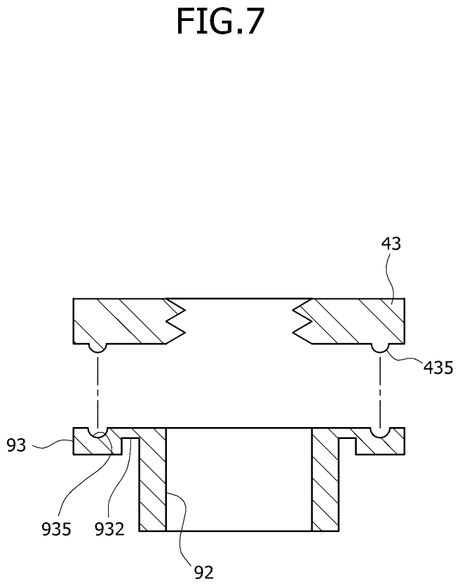

FIG. 7 is a view schematically illustrating the upper insertion portion for maintaining airtightness in FIG. 6, according to another embodiment. Referring to FIG. 7, an upper groove 935 may be formed in an upper insertion portion 93, and an upper nut protrusion 435 to be inserted into the upper groove 935 may be formed on an upper nut 43. The upper nut protrusion 435 may be formed on a bottom surface of the upper nut 43 in a circumferential direction, and the upper groove 935 may be formed in an upper side surface of the insertion upper body 931 in the circumferential direction. When the upper nut protrusion 435 is inserted into the upper groove 935 as the upper nut 43 is screw-coupled to the terminal body 41, an installation position of the upper insertion portion 93 may be corrected. In addition, movement of foreign substances introduced between the upper insertion portion 93 and the upper nut 43 toward the cap hole 32 may be blocked by the upper nut protrusion 435.

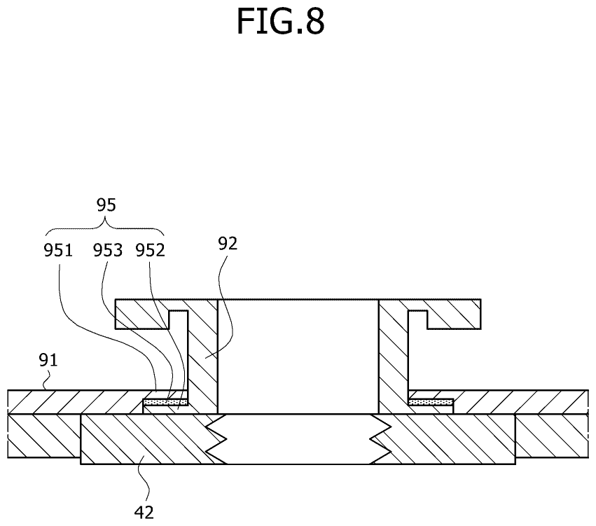

FIG. 8 is a view schematically illustrating the lower insertion portion and the middle insertion portion for maintaining airtightness in FIG. 6, according to another embodiment. Referring to FIG. 8, the lower insertion portion 91 and the middle insertion portion 92 may include a stacked portion 95 in which portions of the lower insertion portion and the middle insertion portion vertically overlap.

The stacked portion 95 may include a lower stacked portion 951 extending from an end of the lower insertion portion 91 and a middle stacked portion 952 extending from the middle insertion portion 92. The lower stacked portion 951 may extend from an upper end of an inner peripheral surface of the lower insertion portion 91 toward the middle insertion portion 92. The middle stacked portion 952 may extend from a lower end of the middle insertion portion 92 in the direction of an outer peripheral surface, and may be disposed to face the lower stacked portion 951. Between the lower stacked portion 951 and the middle stacked portion 952, a space may be formed or a shrinkable buffer stacked portion 953 may be disposed. In the above-described state, when a tightening force is generated by the lower nut 42, the space between the lower stacked portion 951 and the middle stacked portion 952 may be reduced or the buffer stacked portion 953 may be shrunk. The stacked portion 95 may suppress interference between the lower insertion portion 91 and the middle insertion portion 92 due to a tightening force of the lower nut 42.

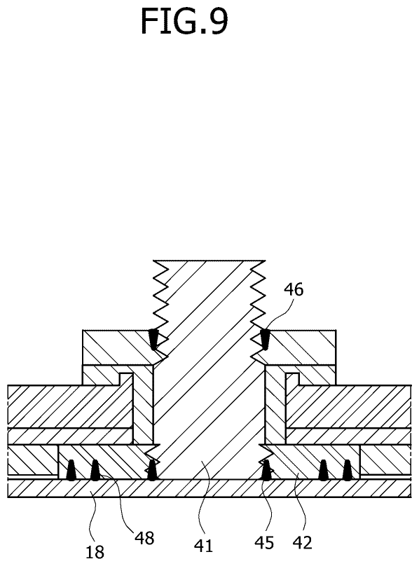

FIG. 9 is a view schematically illustrating a lower welding portion and an upper welding portion according to an embodiment of the present invention. Referring to FIG. 9, the terminal 40 may further include a lower welding portion 45 and an upper welding portion 46.

The lower welding portion 45 may weld the lower nut 42 and the terminal body 41. After the lower nut 42 is screw-coupled to the boss lower section 412, welding may be performed to close a gap between the lower nut 42 and the boss lower section 412.

The upper welding portion 46 may weld the upper nut 43 and the terminal body 41. After the upper nut 43 is screw-coupled to the boss upper section 413, welding may be performed to close a gap between the upper nut 43 and the boss upper section 413. In an embodiment, each of the tab welding portions 48 may weld the electrode tab 18 and the lower nut 42.

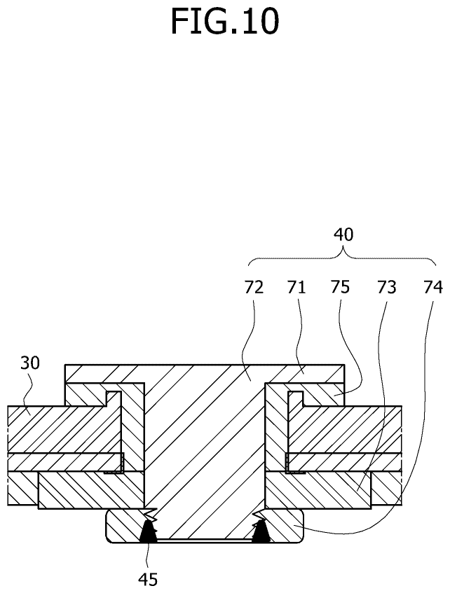

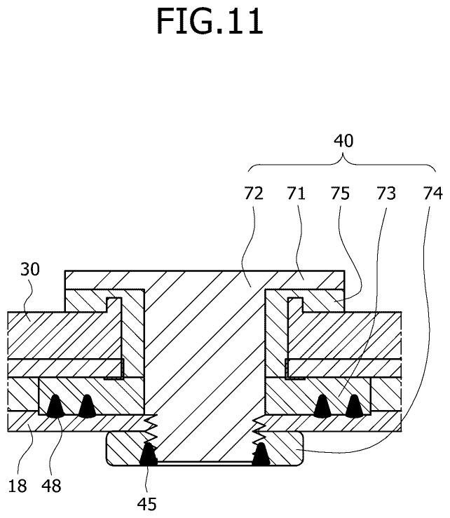

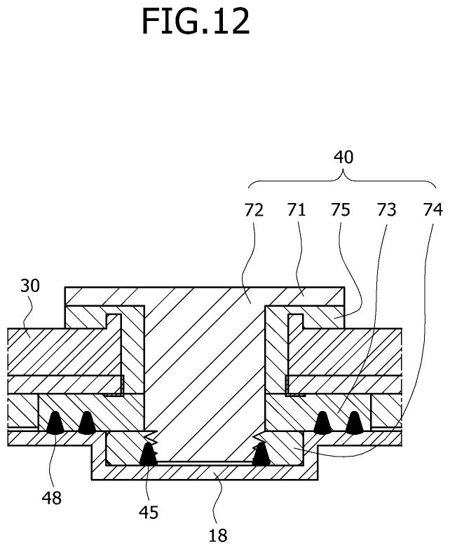

FIG. 10 is a cross-sectional view schematically illustrating a terminal according to another embodiment of the present invention; FIG. 11 is a view schematically illustrating a state in which an electrode tab is disposed between a third terminal and a fourth terminal of FIG. 10; and FIG. 12 is a view schematically illustrating a state in which the electrode tab is disposed outside the third terminal and the fourth terminal of FIG. 10. Referring to FIGS. 10 to 12, a terminal 40 according to another embodiment of the present invention may include a first terminal 71, a second terminal 72, a third terminal 73, a fourth terminal 74, and a fifth terminal 75.

The first terminal 71 may be disposed above a cap cover 30. In an embodiment, the first terminal 71 may have a disk shape and may be coupled to a bus bar 60 using a rivet method. A diameter of the first terminal 71 may be larger than a diameter of a cap hole 32.

The second terminal 72 may extend downward from the first terminal 71 and pass through the cap cover 30. In an embodiment, the second terminal 72 may be formed integrally with the first terminal 71, may have a cylindrical shape, and may pass through the cap plate 31 through the cap hole 32.

The third terminal 73 may be disposed below the cap cover 30 and allow the second terminal 72 to pass therethrough to be coupled to the electrode tab 18. The third terminal 73 may include a conductive material and have a hole formed in a central portion such that a lower portion of the second terminal 72 may pass therethrough.

The fourth terminal 74 may be coupled to a lower end of the second terminal 72 to restrain the third terminal 73. The fourth terminal 74 may be screw-coupled to the lower end of the second terminal 72 by having a thread formed in a hole formed in the central portion. In an embodiment, a lower welding portion 45 may increase a coupling force between the fourth terminal 74 and the second terminal 72 by additionally welding the terminals.

The fifth terminal 75 made of an insulating material may be disposed between the cap cover 30 and the first to third terminals 71 to 73. In an embodiment, the fifth terminal 75 may be divided into multiple pieces. The fifth terminal 75 may correspond to the configuration of the terminal insertion portion 44 illustrated in FIGS. 5 and 6, and further detailed description thereof will be omitted.

The electrode tab 18 may be welded to at least one of the third terminal 73 and the fourth terminal 74. In a first example, the electrode tab 18 through which the second terminal 72 passes is disposed on a bottom surface of the third terminal 73. In the above state, when the fourth terminal 74 is screw-coupled to the lower portion of the second terminal 72, the electrode tab 18 is in close contact with the third terminal 73. In an embodiment, after the fourth terminal 74 is coupled to the second terminal 72, the electrode tab 18 may be maintained in a state of being coupled to the third terminal 73 by welding (see FIG. 11). In an embodiment, after the fourth terminal 74 is coupled to the lower portion of the second terminal 72, the electrode tab 18 may be coupled to exposed surfaces of the second terminal 72 and the fourth terminal 74 by welding (see FIG. 12). In an embodiment, the tab welding portion 48 may weld the terminal 40 and the electrode tab 18.

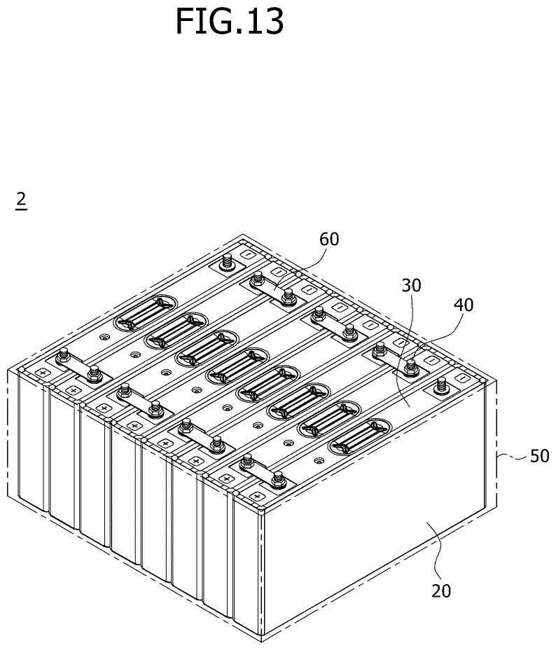

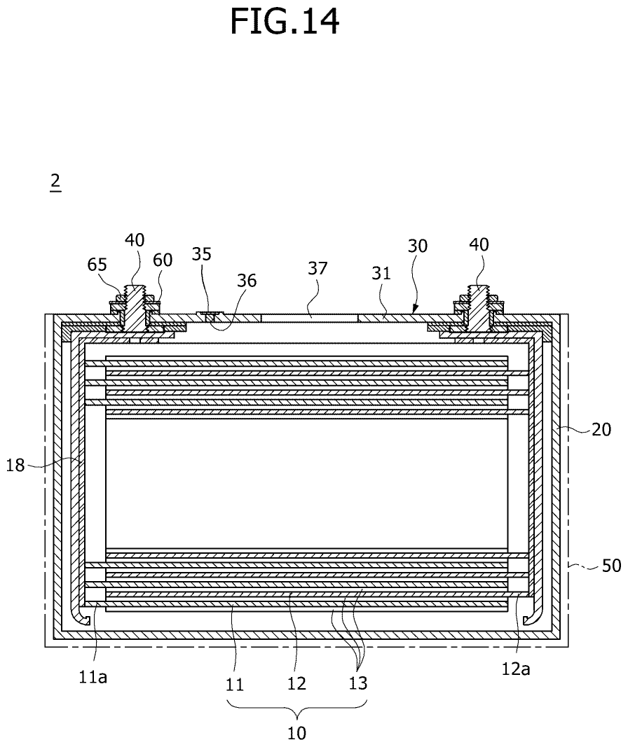

FIG. 13 is a perspective view schematically illustrating a battery module according to an embodiment of the present invention; and FIG. 14 is a cross-sectional view schematically illustrating the battery module according to an embodiment of the present invention. Referring to FIGS. 13 and 14, a battery module 2 according to an embodiment of the present invention includes cases 20, cap covers 30, terminals 40, a housing 50, and bus bars 60. Tab welding portions 48 weld lower portions of the terminals 40 and electrode tabs 18 provided on the electrode assembly 10.

In an embodiment, one or more electrode assemblies 10 may be wound with a separator 13, which is an insulator, interposed between a positive electrode 11 and a negative electrode 12. The positive electrode 11 and the negative electrode 12 may include a coated portion, which is a region where a current collector formed of a thin metal foil is coated with an active material, and uncoated portions 11a and 12a, which are regions that are not coated with the active material. In an embodiment, the positive electrode 11 and the negative electrode 12 may be wound after interposing the separator 13, which is an insulator, therebetween. However, the present invention is not limited thereto, and the electrode assembly 10 may have a structure in which positive electrodes and negative electrodes composed of a plurality of sheets are alternately stacked with a separator interposed therebetween.

The electrode assembly 10 may be built into, or housed or arranged in, the case 20. A plurality of cases 20 may be arranged in a row, and the electrode assembly 10 may be built into the case 20. The case 20 may be made of a conductive metal, such as aluminum, an aluminum alloy, or nickel-plated steel. In addition, the case 20 may have an open upper side or opening and provide a space in which the electrode assembly 10 is accommodated.

The cap cover 30 may cover an open region of the case 20. The cap cover 30 may be coupled to an upper side of each of the cases 20 and may cover the open region of the case 20. The cap cover 30 in contact with the case 20 may be made of a conductive material.

Each of the terminals 40 may be assembled to the cap cover 30 through the cap cover 30. The terminal 40 may be connected to the electrode assembly 10 and formed of a conductive material. The terminal 40 may pass through the cap cover 30, and a lower portion thereof may be built into the case 20 and in contact with the electrode assembly 10, and an upper portion may protrude out of the case 20. The electrode tab 18 connected to the electrode assembly 10 may be in contact with the terminal 40.

The housing 50 may accommodate the cases 20 arranged in a row. The housing 50 may be formed to have a space allowing the cases 20 arranged in a row to be inserted therein. In addition, the housing 50 may be coupled to bottom and side surfaces of the cases 20 arranged in a row, and thus modularity may be implemented.

The bus bar 60 may connect the terminals 40. A pair of positive and negative terminals 40 may be formed in a battery cell 1, and the bus bar 60 may electrically connect a battery cell 1 to a neighboring battery cell 1. In an embodiment, the bus bar 60 may remain in a fixed state by bar nuts 65 assembled to the externally protruding terminals 40 through the terminals 40.

In the battery module 2 according to an embodiment of the present invention, a plurality of battery cells 1 according to an embodiment of the present invention are arranged in a row, and the plurality of battery cells 1 are modularized and electrically connected through the housing 50 and the bus bar 60. The drawings and descriptions illustrated in FIGS. 3 to 10 previously described with respect to the battery cell 1 may be applied to configurations of the cap cover 30 and the terminal 40.

In a battery cell and a battery module according to one or more embodiments of the present invention, since upper and lower portions of a terminal are coupled with nuts, it is possible to improve assembly, reduce a number of parts, and stably secure a sealing force.

In the battery cell and the battery module according to one or more embodiments of the present invention, a cap protrusion protrudes upward from a cap plate and thus comes into close contact with a terminal insertion portion, and inflow of foreign substances from entering from the outside toward a cap hole may thereby be suppressed.

In the battery cell and the battery module according to one or more embodiments of the present invention, a lower nut is screw-coupled to the lower portion of a terminal body, an upper nut is screw-coupled to an upper portion of the terminal body, and the screw coupling portions are welded, and a fastening force may thereby be stably maintained for a long period of time.

According to another aspect of one or more embodiments of the present invention, a battery pack manufactured using a battery with an improved structure and a vehicle including the same are provided.

While the present disclosure has been described with reference to some example embodiments shown in the drawings, these embodiments are merely illustrative and it is to be understood that various modifications and other equivalent embodiments can be derived by those skilled in the art on the basis of the embodiments. Therefore, the technical scope of the present disclosure should be defined by the claims.

What is claimed is:

1. A battery cell comprising:
one or more electrode assemblies, each comprising a positive electrode and a negative electrode;
a case in which the one or more electrode assemblies are arranged;
a cap cover configured to cover an opening of the case;
a terminal assembled to the cap cover through the cap cover; and
a tab welding portion configured to weld a lower portion of the terminal and an electrode tab arranged on the electrode assembly.

2. The battery cell as claimed in claim 1, wherein the cap cover comprises:
a cap plate configured to cover the case;
a cap hole extending through the cap plate such that the terminal is configured to pass therethrough; and
a cap protrusion formed on the cap plate and protruding around the cap hole.

3. The battery cell as claimed in claim 1, wherein the terminal comprises:
a terminal body passing through the cap cover;
a lower nut coupled to a lower portion of the terminal body and welded to the electrode tab;
an upper nut coupled to an upper portion of the terminal body; and
a terminal insertion portion made of an insulating material and arranged between the cap cover and the terminal body.

4. The battery cell as claimed in claim 3, wherein the terminal body comprises:
a body boss passing through the cap cover;
a boss lower section below the body boss, arranged below the cap cover, and screw-coupled to the lower nut; and
a boss upper section on the body boss, arranged above the cap cover, and screw-coupled to the upper nut.

5. The battery cell as claimed in claim 4, wherein the terminal body further comprises a body stopper on the body boss and configured to restrict movement of the lower nut and the upper nut.

6. The battery cell as claimed in claim 3, wherein the terminal insertion portion comprises:
a lower insertion portion between the lower nut and the cap cover;
a middle insertion portion between the cap cover and the terminal body; and
an upper insertion portion connected to the middle insertion portion and located between the upper nut and the cap cover.

7. The battery cell as claimed in claim 6, wherein an upper groove is formed in the upper insertion portion, and
the upper nut comprises an upper nut protrusion inserted in the upper groove.

8. The battery cell as claimed in claim 6, wherein the lower insertion portion and the middle insertion portion comprise a stacked portion in which portions of the lower insertion portion and the middle insertion portion vertically overlap.

9. The battery cell as claimed in claim 1, wherein the terminal comprises:
a first terminal above the cap cover;
a second terminal extending downward from the first terminal and passing through the cap cover;
a third terminal below the cap cover and configured to allow the second terminal to pass therethrough to be coupled to the electrode tab;
a fourth terminal coupled to a lower end of the second terminal to restrain the third terminal; and
a fifth terminal made of an insulating material and arranged between the cap cover and the first terminal, the second terminal, and the third terminal.

10. The battery cell as claimed in claim 9, wherein the electrode tab is welded to at least one of the third terminal and the fourth terminal.

11. A battery module comprising:
cases in which one or more electrode assemblies, each comprising a positive electrode and a negative electrode, are arranged and that are arranged in a row;
cap covers configured to cover openings of the cases, respectively;
terminals assembled to the cap covers through the cap covers, respectively;
tab welding portions configured to weld lower portions of the terminals and electrode tabs arranged on the electrode assemblies;
a housing accommodating the cases; and
a bus bar configured to connect the terminals.

12. The battery module as claimed in claim 11, wherein each of the cap covers comprises:
a cap plate configured to cover a case of the cases;
a cap hole extending through the cap plate such that the terminal is configured to pass through; and
a cap protrusion on the cap plate and protruding around the cap hole.

13. The battery module as claimed in claim 11, wherein each of the terminals comprises:
a terminal body passing through the cap cover;
a lower nut coupled to a lower portion of the terminal body and welded to the electrode tab;
an upper nut coupled to an upper portion of the terminal body; and
a terminal insertion portion made of an insulating material and arranged between the cap cover and the terminal body.

14. The battery module as claimed in claim 13, wherein the terminal body comprises:
a body boss passing through the cap cover;
a boss lower section below the body boss, below the cap cover, and screw-coupled to the lower nut; and
a boss upper section on the body boss, above the cap cover, and screw-coupled to the upper nut.

15. The battery module as claimed in claim 14, wherein the terminal body further comprises a body stopper on the body boss and configured to restrict movement of the lower nut and the upper nut.

16. The battery module as claimed in claim 13, wherein the terminal insertion portion comprises:
a lower insertion portion between the lower nut and the cap cover;
a middle insertion portion between the cap cover and the terminal body; and
an upper insertion portion connected to the middle insertion portion and arranged between the upper nut and the cap cover.

17. The battery module as claimed in claim 16, wherein an upper groove is formed in the upper insertion portion, and
the upper nut comprises an upper nut protrusion inserted in the upper groove.

18. The battery module as claimed in claim 16, wherein the lower insertion portion and the middle insertion portion comprise a stacked portion in which portions of the lower insertion portion and the middle insertion portion vertically overlap.

19. The battery module as claimed in claim 11, wherein each of the terminals comprises:
a first terminal above the cap cover;
a second terminal extending downward from the first terminal and passing through the cap cover;
a third terminal below the cap cover and configured to allow the second terminal to pass therethrough to be coupled to the electrode tab;
a fourth terminal coupled to a lower end of the second terminal to restrain the third terminal; and
a fifth terminal made of an insulating material and arranged between the cap cover and the first terminal, the second terminal, and the third terminal.

20. The battery module as claimed in claim 19, wherein the electrode tab is welded to at least one of the third terminal and the fourth terminal.
